(19) United States
(12) Patent Application Publication
(10) Pub. No.: US 2012/0182382 A1
(43) Pub. Date: Jul. 19, 2012

(54) DOOR MOUNTED 3D VIDEO MESSAGING SYSTEM

(76) Inventor: Pedro Serramalera, Westlake Village, CA (US)

(21) Appl. No.: 13/079,703

(22) Filed: Apr. 4, 2011

Related U.S. Application Data
(60) Provisional application No. 61/433,234, filed on Jan. 16, 2011.

(51) Int. Cl. H04N 7/15

(52) U.S. Cl. 348/14.07; 348/E07.083; 348/E13.001

(57) ABSTRACT

A video communication system includes a 3D video recording system, a 3D video display system, a first control for activating the 3D recording system to record a video message, a second control for playing back the video message on the 3D display, a power supply, and a microprocessor configured to: receive input commands from the first control and the second control, receive video data from the 3D video recording system, and control the 3D video recording system and the 3D video display system.

### CROSS-REFERENCE TO RELATED APPLICATION(S)

This application claims priority to U.S. Provisional Patent Application No. 61/433,234 filed on Jan. 16, 2011 in the United States Patent and Trademark Office, the entire disclosure of which is incorporated herein by reference.

### BACKGROUND

A peephole is a typical feature of a residential front door, but is uncommon in the front door of a business. A peephole is generally of limited use because a user must be physically present at the peephole in order to perceive a visitor outside the front door.

In the field of household security systems, front door security cameras are typically used to allow users inside a home to view or record a video image of a visitor outside the door to a remote location within the building. Some household security systems also provide intercom capabilities. However, such security systems typically do not include a mechanism for a visitor to leave a message for the resident.

Residential front door security cameras and intercom systems also often involve lengthy or difficult installation procedures because the weight and bulk of the cameras typically require them to be mounted onto or into the walls.

### SUMMARY

Embodiments of the present invention are directed to a system providing a 3D video messaging system. According to one embodiment, a video communication system includes a 3D video recording system, a 3D video display system, a first control for activating the 3D recording system to record a video message, a second control for playing back the video message on the 3D display, a power supply, and a microprocessor configured to receive input commands from the first control and the second control, receive video data from the 3D video recording system, and control the 3D video recording system and the 3D video display system.

In one embodiment, the 3D recording system includes a 3D camera system, a microphone, and a memory, wherein the microprocessor is further configured to receive audio data from the microphone.

In one embodiment, the 3D video display system is an autostereoscopic 3D display.

In one embodiment, the video communication system further includes a network communication device, such as a wireless network communication device and the microprocessor is further configured to transmit the video message via the network communication device to a personal computing device such as a smartphone, a personal computer, or a tablet computer.

In one embodiment, the 3D recording system is configured to be attached to an outside surface of a door, the 3D display system is configured to be attached to an inside surface of a door, and the 3D recording system and the 3D display system are coupled to each other through a peephole of the door.

In one embodiment, the video communication system further includes a doorbell control coupled to the microprocessor, wherein the microprocessor is further configured to activate a notification, record video received from the 3D recording system for a period of time, and increment a doorbell ring counter when the doorbell control is activated.

In another aspect, the invention provides an improved door having an inside surface, an outside surface, and a peephole extending between the inside surface and the outside surface, wherein the improvement includes a 3D video recording system coupled to the outside surface, a 3D video display system, a first control for activating the 3D recording system to record a video message, a second control for playing back the video message on the 3D display, a power supply, and a microprocessor configured to receive input commands from the first control and the second control, receive video data from the 3D video recording system, and control the 3D video recording system and the 3D video display system.

### BRIEF DESCRIPTION OF THE DRAWINGS

Together with the specification, the accompanying drawings illustrate exemplary embodiments of the present invention, wherein:

FIG. 1 is a front view of an outwardly facing portion of a video messaging system according to one embodiment of the invention.

FIG. 2 is a front view of an inwardly facing portion of a video messaging system according to one embodiment of the invention.

FIG. 3 is a side view illustrating outwardly and inwardly facing portions of a video messaging system according to one embodiment of the invention in which the outwardly and inwardly facing portions are mounted to a door.

FIG. 4 is a block diagram illustrating the internal structure of a video messaging system according to one embodiment of the invention.

FIG. 5 is a front view of an outwardly facing portion of a video messaging system according to one embodiment of the invention.

### DETAILED DESCRIPTION

In the following detailed description, only certain exemplary embodiments of the present invention are shown and described, by way of illustration. As those skilled in the art will recognize, the invention can be embodied in many different forms and should not be construed as being limited to the embodiments set forth herein. Also, in the context of the present application, when an element is referred to as being “on” another element, it can be directly on the other element, or indirectly on the other element with one or more intervening elements interposed therebetween. Like reference numerals designate like elements throughout the specification.

According to the invention, a 3D video messaging system is provided and allows visitors to leave a 3D video message at the front door of a home when nobody answers the bell by activating a “leave video message” control, optionally, after the visitor has first rung the doorbell. In some embodiments, the 3D video messaging system is further configured to display a 3D video messages left by a visitor on a 3D display integrated into the system, and in other embodiments the 3D video messaging system can transmit the 3D video messages to be played on an external device such as a smartphone or a computer.

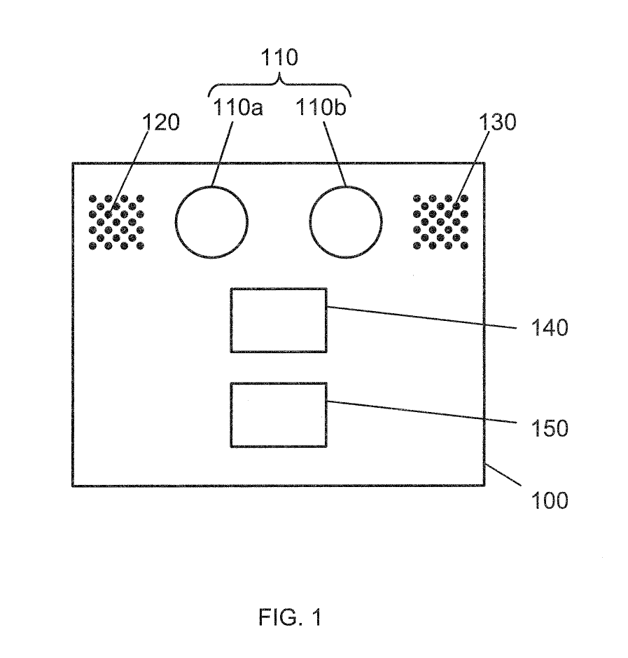

A 3D video messaging system according to one embodiment of the present invention is described in more detail below in reference to FIGS. 1 through 5.

FIG. 1 is a front view of an outwardly facing portion 100 of a video messaging system. The outwardly facing portion 100 includes two cameras 110a and 110b, a microphone 120, a speaker 130, a doorbell control 140, and a record message control 150 (which may be referred to as a first control). In one embodiment, the outwardly facing portion 100 can be mounted on an outside surface of a door.

Each of the cameras 110 includes a lens and a digital image sensor such as a CMOS or CCD sensor. In one embodiment, the cameras 110 may also include one or more signal processors for controlling the read-out of data from the digital image sensors and for converting the detected signals into video data. In some embodiments, the signal processors further include components for the compression of video (which may be referred to as a “codec”) into standard formats such as MPEG-2, H.263, and H.264/MPEG-4 and output digital data.

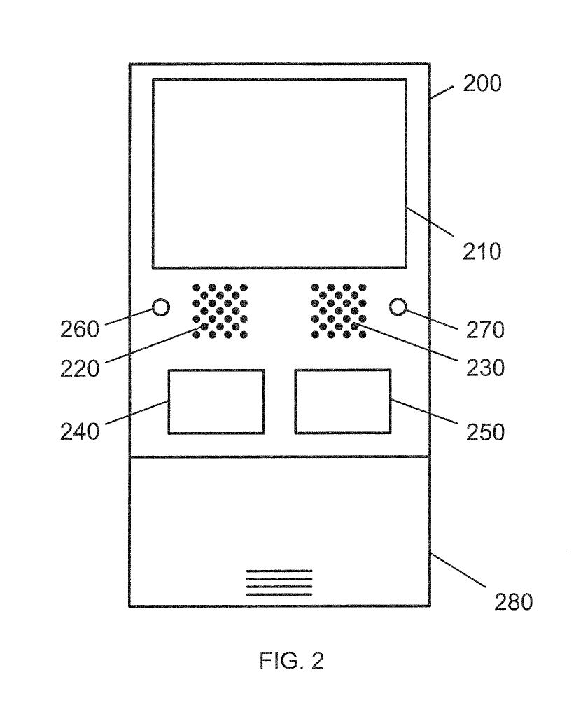

FIG. 2 is a front view of an inwardly facing portion 200 of a video messaging system according to one embodiment of the invention. The inwardly facing portion 200 includes a 3D display 210, a microphone 220, a speaker 230, a playback control 240, a recording control 250, a message indicator 260, a battery indicator 270, and a battery compartment 280. The inwardly facing portion 200 can be mounted on an inside surface of a door.

In one embodiment, the 3D display 210 is a stereoscopic display (e.g., based on polarized glasses) or an autostereoscopic (or “glasses free”) 3D display (e.g., using a parallax barrier or a lenticular lens).

The message indicator 260 and the battery indicator 270 are illustrated in the embodiment shown in FIG. 2 as separate indicators (e.g., LED lights) but in other embodiments are displayed on the 3D display 210. For example, in one embodiment an envelope icon is displayed on the 3D display when unviewed messages are awaiting viewing.

In some embodiments of the invention, the 3D display 210 includes a touch sensitive panel, and the playback control 240 and the recording control 250 are implemented as controls, which are displayed and which are activated by touching the display panel. Touch screen panels are well known in the art and are based on, for example (but not limited to), capacitive, resistive, surface acoustic wave, infrared, optical imaging, dispersive signal, and acoustic pulse recognition detection technologies.

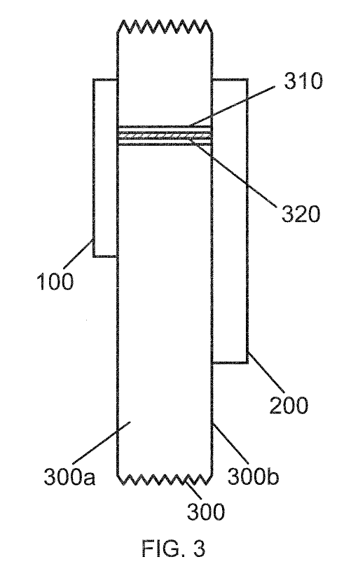

FIG. 3 is a side view of a 3D video messaging system according to one embodiment of the invention in which the outwardly facing portion 100 is affixed to an outside surface 300a of a door 300, and the inwardly facing portion 200 is affixed to an inside surface 300b of the door 300.

The door includes a hole (e.g., a peephole) 310 through which electrical wiring 320 is threaded, and the electrical wiring 320 electrically couples the outwardly facing portion 100 to the inwardly facing portion 200.

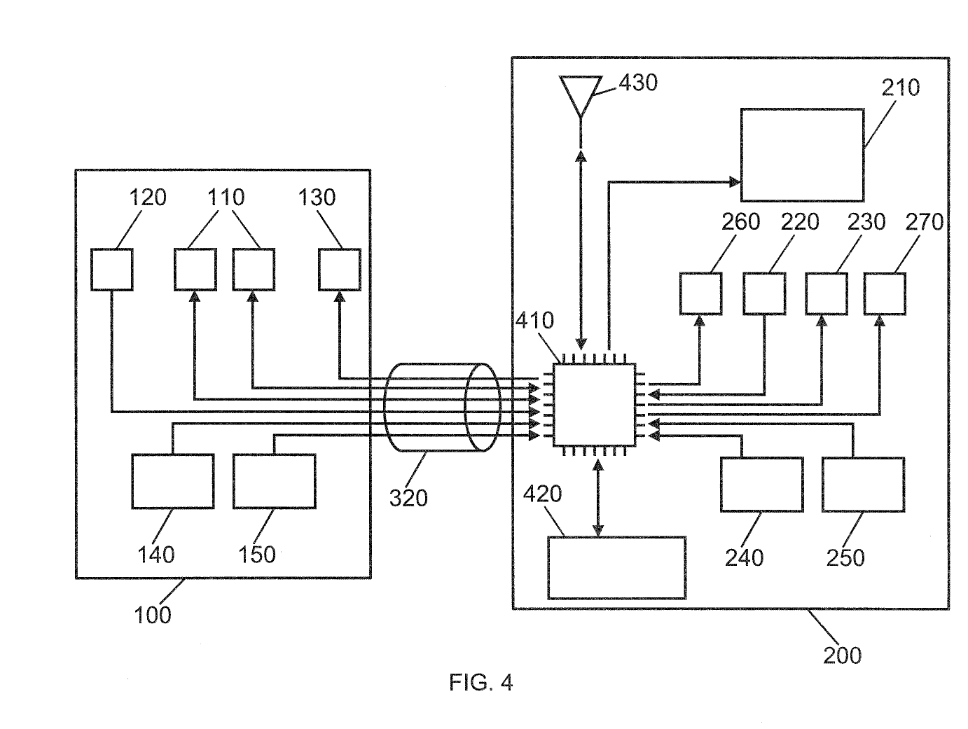

FIG. 4 is a block diagram illustrating the internal structure of a video messaging system according to one embodiment of the invention. The video messaging system includes a microprocessor 410 configured to control the video messaging system. The microprocessor can be controlled by a computer program stored in memory 420 or memory integrated into the microprocessor 410. In some embodiments, memory 420 is flash memory (e.g., NOR or NAND flash), dynamic random-access memory (DRAM), or static random access memory (SRAM).

As illustrated in the embodiment of FIG. 4, the microprocessor is electrically coupled to the each of the components in the 3d video messaging system. In some embodiments the microprocessor is directly coupled to each of the components, and in other embodiments other components, such as digital signal processors and audio and video compression/decompression processors, are located between the microprocessor and some of the components illustrated in FIG. 4.

The operation of the 3D video messaging system according to one embodiment illustrated in FIG. 4 is described below in more detail.

In some circumstances, a visitor approaches a door on which the 3D video system is mounted and activates the doorbell control 140 such as a momentary push-button switch. The activation of the doorbell control 140 is detected by the microprocessor 410 which is configured to play one or more sounds through the internal speaker 230 to indicate that the doorbell control 140 has been activated (i.e., the doorbell has been rung). In one embodiment, the notification sounds played through the internal speaker are selected from prerecorded sounds or are previously recorded or supplied by a user. In some embodiments, the microprocessor is also configured to activate the cameras 110 and the microphone 120 to record video for a configurable amount of time (e.g., 10 seconds) after the doorbell has been rung. The process of recording video from the cameras 110 is described below in more detail.

A visitor can also manually activate the record message control 150 in order to leave a video message. Like the doorbell control 140, the record message control 150 can be a momentary push-button switch. The microprocessor 410 is configured to detect the activation of the record message control 150 and to activate the cameras 110 and the microphone 120 in response.

As discussed above, the cameras 110 supply digital video data to the microprocessor 410, which writes the digital video data to the memory 420. In some embodiments, a direct memory access (DMA) method is used in which the digital video data is written directly to the memory 420 without passing through the microprocessor 410. Each of the cameras 110 supplies video data taken from a different angle.

Similarly, the microphone 120 outputs an analog audio signal which is processed by an analog to digital (A/D) converter to produce digital audio data. In some embodiments, the A/D converter is a standalone component, is integrated into the microprocessor 410, or is integrated into the microphone 120. The digital audio data is also written into the memory 420.

In one embodiment, the digital video data and the digital audio data are stored and associated with timestamps corresponding to the start and stop times of the recording of the audio and video. In one embodiment, the video and audio data are also associated with a flag indicating whether the message is “unviewed” or “viewed.” When the message is initially stored in the memory, the flag is set to the “unviewed” state.

The message indicator 260 is activated when at least one message stored in the memory has its flag set in the “unviewed” state.

The playback control 240 is used to play back messages stored in the memory 420. For example, in one embodiment, the microprocessor 410 is configured to play back messages starting from the oldest unviewed message and move forward in time through the unviewed messages when the playback control 240 is activated. In one embodiment, the microprocessor is configured to change the flag on each message to the “viewed” state after it has been played.

During playback, the video data stored in the memory 420 is supplied to the 3D display 210 via the processor 410. In other embodiments, the video data is supplied directly to the display 210. In addition, in some embodiments, a separate video decompression chip is used to decompress the compressed video for playback on the 3D display 210. The 3D video data is supplied to the 3D display such that an appropriate image is supplied to the appropriate eye of a user such that a 3D effect is perceived.

Similarly, during playback, audio data is supplied from the memory 420 and converted to an analog voltage which is supplied to the speaker 230 in synchrony with the supply of the video data to the 3D display 210.

In one embodiment, the inwardly facing portion 200 further includes additional controls, such as a four-way controller (up, down, left, right) and a selection button in order to provide control over an on-screen or menu-driven interface in order to provide additional control over the selection and playback of messages stored in the memory 420.

In one embodiment, the inwardly facing portion 200 further includes a delete message control for deleting messages from the memory 420. The delete message control may be implemented as, but is not limited to, a separate physical button or a selectable function in a graphical user interface (e.g., a touch screen or menu driven interface).

In some embodiments, 3D video messaging system is further configured to communicate with an external device such as a smartphone, a computer, a tablet, or a television via a network interface device 430. Non-limiting examples of such devices include wireless network interface devices operating over network communication systems, e.g., a Wi-Fi™ network, a Bluetooth™ connection, and an Ethernet connection. For example, in one embodiment, the microprocessor 410 is configured to transmit a message to an external device to indicate that the doorbell control 140 was activated.

In some embodiments, the video messages are also transmitted to a user via the network interface device 430. For example, in one embodiment, the video messages are delivered to a server for storage and streaming playback, delivered via email to a user's inbox, delivered to a user's phone via the multimedia messaging service (MMS), or delivered to a user via the Extensible Messaging and Presence Protocol (XMPP). In addition, in one embodiment, the 3D video messaging system supplies notification of a new message to a user's cell phone via a text message (SMS). The messages are also be delivered to or viewed in a dedicated application (such as the Skype™ client software) running on a personal computing device such as a smartphone, a computer, a tablet, a television.

In one embodiment, the server or other external storage device for messages are used when the memory 420 has been filled to capacity or when users wish to free up space in the memory 420 and to save messages for a longer period of time. In some embodiments, the memory 420 is merely used as a buffer to store the 3D messages before transmission to the server or other external storage device.

In some embodiments, a user records a greeting message to be played to the visitor. For example, the microphone 220 on the inwardly facing portion 200 can be used to record a message to be stored in memory 420 and played on the speaker 130 of the outwardly facing portion 100 when the doorbell control 140 is activated. In other embodiments of the present invention, the outwardly facing portion 100 further includes a 3D display for displaying a video greeting.

In embodiments in which the 3D video messaging system is battery powered, a battery indicator 270 is used to indicate the battery level to the user.

In some embodiments of the present invention, the microprocessor 410 and the network communication device are located in the outwardly facing portion 100. In some embodiments of the invention, both the outwardly facing portion 100 and the inwardly facing portion 200 include microprocessors and network communication devices, and the outwardly facing and inwardly facing portions communicate via the network communication devices instead of the wiring 320.

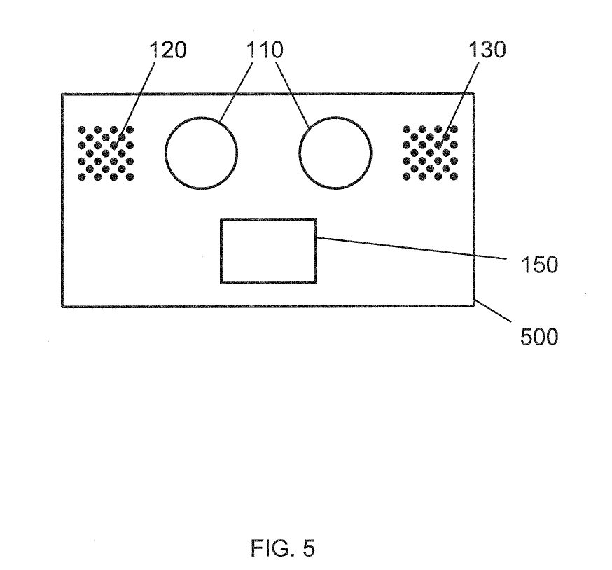

According to another embodiment of the present invention illustrated in FIG. 5, the outwardly facing portion 500 is substantially the same as the outwardly facing portion 100 illustrated in FIG. 1, except that the outwardly facing portion 500 of FIG. 5 does not include a doorbell control.

While the present invention has been described in connection with certain exemplary embodiments, the invention is not limited to such embodiments, but encompasses various modifications and equivalent arrangements included within the scope of the appended claims and equivalents thereof.

What is claimed is:

1. A video communication system comprising:
a 3D video recording system;
a 3D video display system;
a first control for activating the 3D recording system to record a video message;
a second control for playing back the video message on the 3D display;
a power supply; and
a microprocessor configured to:
receive input commands from the first control and the second control;
receive video data from the 3D video recording system; and
control the 3D video recording system and the 3D video display system.

2. The video communication system of claim 1, wherein the 3D recording system comprises:
a 3D camera system;
a microphone; and
a memory,
wherein the microprocessor is further configured to receive audio data from the microphone.

3. The video communication system of claim 1, wherein the 3D display system comprises:
a 3D display and
a speaker.

4. The video communication system of claim 3, wherein the 3D display is an autostereoscopic 3D display.

5. The video communication system of claim 1, further comprising a network communication device, and wherein the microprocessor is configured to transmit the video message via the network communication device.

6. The video communication system of claim 5, wherein the network communication device is a wireless network communication device.

7. The video communication system of claim 5, wherein the microprocessor is further configured to transmit the video message via the network communication device to a personal computing device.

8. The video communication system of claim 7, wherein the personal computing device is a smartphone, a personal computer, or a tablet computer.

9. The video communication system of claim 1, wherein:
the 3D recording system is configured to be attached to an outside surface of a door;
the 3D display system is configured to be attached to an inside surface of a door; and
the 3D recording system and the 3D display system are coupled to each other through a peephole of the door.

10. The video communication system of claim 1, further comprising a third control for controlling the video communication system to display a live view of a scene recorded by the 3D video recording system on the 3D video display system.

11. The video communication system of claim 1, further comprising a doorbell control coupled to the microprocessor,
wherein the microprocessor is further configured to:
activate a notification;
record video received from the 3D recording system for a period of time; and
increment a doorbell ring counter
when the doorbell control is activated.

12. The video communication system of claim 11, wherein the notification is a recorded sound played through the 3D video display system.

13. In a door having an inside surface, an outside surface, and a peephole extending between the inside surface and the outside surface, the improvement comprising:
a 3D video recording system coupled to the outside surface;
a 3D video display system;
a first control for activating the 3D recording system to record a video message;
a second control for playing back the video message on the 3D display;
a power supply; and
a microprocessor configured to:
receive input commands from the first control and the second control;
receive video data from the 3D video recording system; and
control the 3D video recording system and the 3D video display system.

14. The improvement of claim 13, wherein the 3D recording system comprises:
a 3D camera system;
a microphone; and
a memory,
wherein the microprocessor is further configured to receive audio data from the microphone.

15. The improvement of claim 13, wherein the 3D display system comprises:
a 3D display and
a speaker.

16. The improvement of claim 15, wherein the 3D display is an autostereoscopic 3D display.

17. The improvement of claim 13, further comprising a network communication device, and wherein the microprocessor is configured to transmit the video message via the network communication device.

18. The improvement of claim 17, wherein the microprocessor is further configured to transmit the video message via the network communication device to a personal computing device.

19. The improvement of claim 13, wherein the 3D recording system and the 3D display system are coupled to each other through the peephole.

20. The improvement of claim 13, further comprising a third control for controlling the video communication system to display a live view of a scene recorded by the 3D video recording system on the 3D video display system.
